(19) United States
(12) Patent Application Publication
(10) Pub. No.: US 2016/0321592 A1
(43) Pub. Date: Nov. 3, 2016

(54) PROMOTING ACHIEVEMENT OF A GOAL IN A PROFESSIONAL COMMUNITY

(71) Applicant: LinkedIn Corporation, Mountain View, CA (US)

(72) Inventors: Yang Zhou, San Jose, CA (US); Kyle Ramsay, San Francisco, CA (US); Barry Huang, San Jose, CA (US); Xin Fu, Santa Clara, CA (US)

(73) Assignee: LINKEDIN CORPORATION, Mountain View, CA (US)

(21) Appl. No.: 14/754,051

(22) Filed: Jun. 29, 2015

Related U.S. Application Data
(60) Provisional application No. 62/155,314, filed on Apr. 30, 2015.

(51) Int. Cl. G06Q 10/06; G06Q 30/02

(52) U.S. Cl. CPC G06Q 10/06393; G06Q 30/0207

(57) ABSTRACT

A system, method, and apparatus are provided for promoting achievement of a goal within a professional community, such as an online professional network. A member is selected as a candidate for assistance based on her level of usage of the community and/or other factors, and a goal of the member may be learned explicitly or implicitly. Based on her goal and her level of proficiency within the community, which may be determined based on the number of discrete tasks or metrics she has accomplished, a set of milestones is suggest to her. The milestones are both related to the member's goal and customized to her level of proficiency. Upon completion of the milestones, she may be given a reward that is related to the goal.

### RELATED APPLICATION

This application claims priority to U.S. Provisional Patent Application No. 62/155,314, which was filed Apr. 30, 2015 and is incorporated herein by reference.

### BACKGROUND

This disclosure relates to the field of computers. More particularly, a system, method, and apparatus are provided for identifying and promoting achievement of goals within a professional community.

Some professional communities, such as an online professional social network, help members achieve professional goals within the communities. However, it is generally up to each individual member to motivate himself or herself in that regard, and the more complex or extensive the professional community, the more difficult it can be for a new member to learn how to use features and services offered by the community.

For example, an individual member must determine what he or she would like to achieve within the community and to figure out how to accomplish that achievement. If a member's motivation wavers, if he or she perceives no tangible or rapid benefit from some particular action within the community, or if he or she cannot determine appropriate actions for pursuing a goal, the member may fail to achieve that goal.

In general, existing professional communities do little to help a member identify a professional goal and/or assist or incentive that member toward achieving that goal, especially in a way that allows or helps the member discover features and benefits of the community he or she has joined.

### DESCRIPTION OF THE FIGURES

FIG. 1 is a block diagram depicting a computing environment in which achievement of professional goals is promoted, in accordance with some embodiments.

FIG. 2 is a flow chart illustrating a method of promoting achievement of goals within a professional community, in accordance with some embodiments.

FIG. 3 depicts an apparatus for promoting achievement of goals within a professional community, in accordance with some embodiments.

FIG. 4 is a table identifying milestones that may be suggested to members, in accordance with some embodiments.

### DETAILED DESCRIPTION

The following description is presented to enable any person skilled in the art to make and use the disclosed embodiments, and is provided in the context of one or more particular applications and their requirements. Various modifications to the disclosed embodiments will be readily apparent to those skilled in the art, and the general principles defined herein may be applied to other embodiments and applications without departing from the scope of those that are disclosed. Thus, the present invention or inventions are not intended to be limited to the embodiments shown, but rather are to be accorded the widest scope consistent with the disclosure.

In some embodiments, a system, method, and apparatus are provided for promoting achievement of goals within an online professional community, such as the community of members of the professional network provided by LinkedIn® Corporation. A goal of a given member may be inferred from his or her activity, or may be explicitly identified by him or her, and suitable milestones or tasks that promote achievement of that goal are then proposed. The member may be given an appropriate award for completion of the milestones, wherein the award is related to the member's goal.

Upon determination of a given member's goal within the community (e.g., to find a job, to expand his or her network of connections, to access interesting content), the milestones that may be proposed or suggested for progressing to that goal are customized to that goal, and are also customized based on the member's proficiency within the community. A given member's ‘proficiency’ may be defined or understood to equate to or be proportional to his or her level of familiarity or experience with the community. Thus, relatively uncomplicated milestones may be suggested to a novice member having a particular goal, while more complex milestones may be suggested to a relatively experienced member.

A member's proficiency within the online professional community may be determined based on his or her frequency (and/or duration) of online sessions, activity within the community, accomplishment of the milestones before/without the milestone tasks being suggested, completion of various actions or activity within the community, etc.

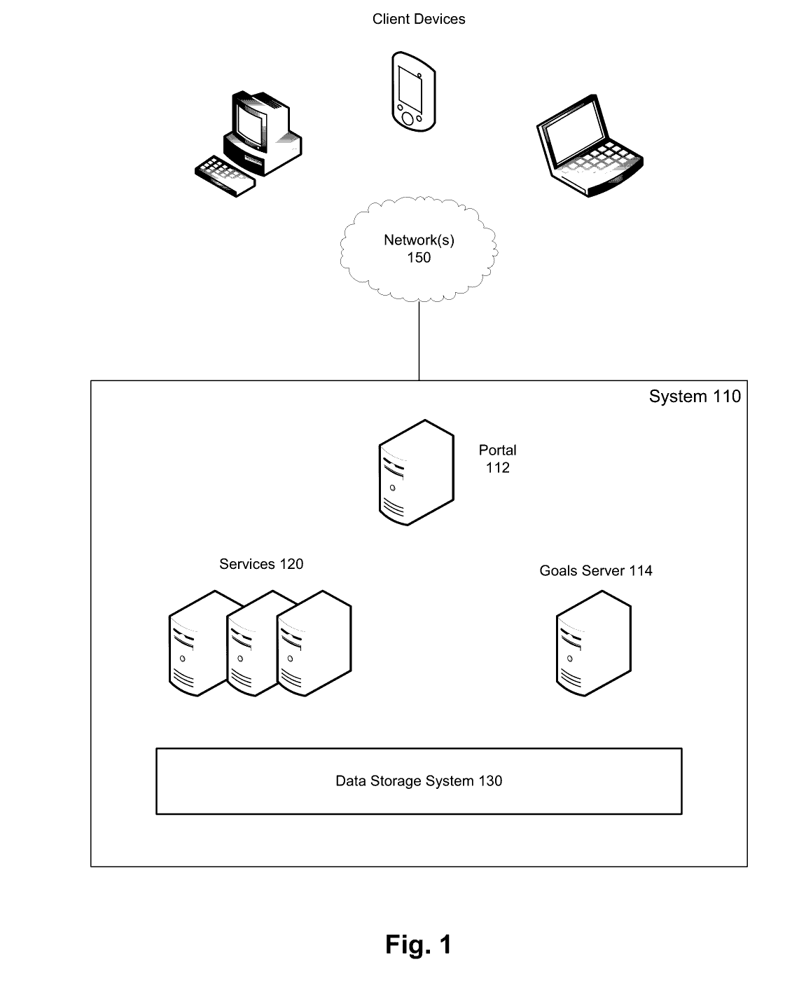

FIG. 1 is a block diagram depicting a computing environment in which achievement of professional goals is promoted, according to some embodiments.

System 110 of FIG. 1 is (or is part of) a data center that supports or hosts an online application or service that features a community or network of users, such as a professional network or a professional social network offered by LinkedIn® Corporation. Users of system 110 may be termed members because they may be required to register with the system in order to use the application or service. Members may be identified and differentiated by username, electronic mail address, telephone number, and/or some other unique identifier.

Users/members of a service or services hosted by system 110 connect to the system via client devices, which may be stationary (e.g., desktop computer, workstation) or mobile (e.g., smart phone, tablet computer, laptop computer). In order to interact with the system (e.g., to view content, submit or edit content) the client devices operate suitable client applications, such as a browser program or an application designed specifically to access a service offered by system 110. In addition, other communication software (e.g., electronic mail, instant messaging) may be executed by a client device in order to communicate with system 110.

Client devices are coupled to system 110 via direct channels and/or one or more networks 150 or other shared channels, which may include the Internet, intranets, and/or other networks, and may incorporate wired and/or wireless communication links.

Via the client devices and the applications they execute, members are able to submit information to the professional community, receive information submitted by other members, exchange messages with other members, and otherwise interact within the community. Various mechanisms or functions may be offered by system 110 to promote such information exchange, to allow members to “share,” “post,” or “like” some particular content, to comment upon or forward the content, to upload or create a link to content, to connect to or to follow another member, to subscribe to content channels, to make and receive endorsements and recommendations, and so on.

Interactive user/member sessions with system 110 are generally made through portal 112, which may comprise a web server, an application server, and/or some other gateway or entry point. The portal through which a given session is established may depend on the member's device or method of connection. For example, a user of a mobile client device may connect to system 110 via a different portal (or set of portals) than a user of a desktop or workstation computer.

System 110 also includes goals server or platform 114, data storage system 130, and various services represented by services 120, which may be hosted by any number of computing machines. Goals server 114 records some or all members' goals (and may be involved in obtaining them, if necessary), identifies suitable milestones to help a given member progress toward a goal, tracks completion of milestones and goals, and may initiate grant of a suitable reward upon completion of a milestone or achievement of a goal. The goals server may also have other functions, as described herein.

Data storage system 130, which may be a distributed data storage system, and/or components of the data storage system (e.g., separate storage engines), include appropriate data storage devices (e.g., disks, solid-state drives), and store data used by portal 112, goals server 114, services 120, and/or other components of system 110 not depicted in FIG. 1.

Among services 120 may be one or more individual computer servers configured to serve content, track/record activity within system 110, maintain member profiles, record member connections, and/or support other services, execute or support an application or community feature, etc.

For example, a profile service or server may maintain profiles of members of the service(s) hosted by system 110, which may be stored in data storage system 130 and/or elsewhere. An individual member's profile may include or reflect any number of attributes or characteristics of the member, including personal (e.g., gender, age or age range, interests, hobbies, member ID), professional (e.g., employment status, job title, job location, employer or associated organization, industry, functional area or role, skills, endorsements, professional awards, seniority), social (e.g., organizations the user is a member of, geographic area of residence, friends), educational (e.g., degree(s), university attended, other training), etc. A member's profile, or attributes or dimensions of a member's profile, may be used in various ways by system components (e.g., to identify or characterize a member who shared or received information, to identify a member's level of proficiency within the community, to characterize content, to select content to serve to a member, to record a content-delivery event).

Organizations may also be members of the service(s) offered by system 110 (i.e., in addition to individuals), and may have associated descriptions or profiles comprising attributes such as industry, size, location, goal or purpose, etc. An organization may be a company, a corporation, a partnership, a firm, a government agency or entity, a not-for-profit entity, a group or collection of associated members, or some other entity formed for virtually any purpose (e.g., professional, social, educational). Either or both organizations and individual members may “follow” and/or be followed by other members, may share and/or received shared information, may initiate and receive communications with other members, may post content and/or receive content posted by other members, etc.

A content service or server may maintain one or more repositories of content items for serving to members (e.g., within data storage system 130 and/or elsewhere), an index of the content items, and/or other information useful in serving content to members. Illustratively, a content server may serve on the order of hundreds of millions of content items or objects every day. A content store may include various types of sponsored and/or unsponsored content items for serving to members and/or for use by various components of system 110, which may be generated within the system or by external entities. A content service (or some other component of system 110) may include a recommendation module for recommending specific content to serve to a member.

A tracking service or server may monitor and record (e.g., within data storage system 130 and/or elsewhere) activity of system 110 and/or members. For example, whenever content or a communication is served by the system (e.g., to a client device), the tracking server may be informed of what is served, to whom (e.g., which member), when it was served, and/or other information. Similarly, the tracking server may also receive notifications of member actions regarding content actions and communications, to include identities of the member and the content acted upon, the action that was taken, when the action was taken, etc. Illustrative actions that may be captured include, but are not limited to, clicks/taps/pinches (on the content, on a logo or image), conversions, follow-on requests, visiting a page associated with a subject or provider of the content, taking some other action regarding the content (e.g., commenting on it, sharing it, following its provider, liking it), and so on.

A tracking service or server may also record members' interaction with or use of services 120, to include dispatch or receipt of a communication (e.g., electronic mail, instant message, a post, a comment, a share, a recommendation, a connection request), alteration or completion of a member profile, uploading of a member's contacts, downloading an application or feature offered by system 110, subscription to a content channel, addition of a skill, sending or receiving an endorsement of a skill, etc.

Specific activities of members of the professional community hosted by system 110 may be monitored by individual activity-specific services or, as described above, may be monitored by a content service, a tracking service, or some other larger service.

A connection service or server may maintain members' connections with other members. Such connections may be stored as a graph, for example, in which different nodes represent different members and a link between two given nodes represents an explicit or implicit connection. An explicit connection may be formed when two members establish a formal connection (e.g., one of them accepts a connection request issued by the other); an implicit connection may be formed automatically when one member takes some action that involves another member (e.g., sends a communication, follows or subscribes to the other member, comments on a post or other content provided by the other user).

Members of a service hosted by system 110 have corresponding “identity” or “home” pages (e.g., web pages, content pages) on the system, which they may use to facilitate their activities with the system and with each other, to form connections/relationships with other members, to view their connections and/or information regarding their connections, to view their goals and/or associated milestones, to review/modify their profiles, to inform friends and/or colleagues of developments in their lives/careers, to send/receive communications, etc. These pages (or information provided to members via these pages) are available to some or all other members. Members' home pages may be stored within data storage system 130 or elsewhere.

System 110 may include other components, services, and/or servers not illustrated in FIG. 1. Also, functionality attributed herein to system 110 may be distributed among its components in an alternative manner, such as by merging or further dividing functions of one or more components, or may be distributed among a different collection of components. Yet further, while depicted as separate and individual hardware components (e.g., computer servers) in FIG. 1, one or more of portal 112, goals server 114, and services 120 may alternatively be implemented as separate software modules executing on one or more computer servers. Thus, although only a single instance of a particular component of system 110 may be illustrated in FIG. 1, it should be understood that multiple instances of some or all components may be utilized.

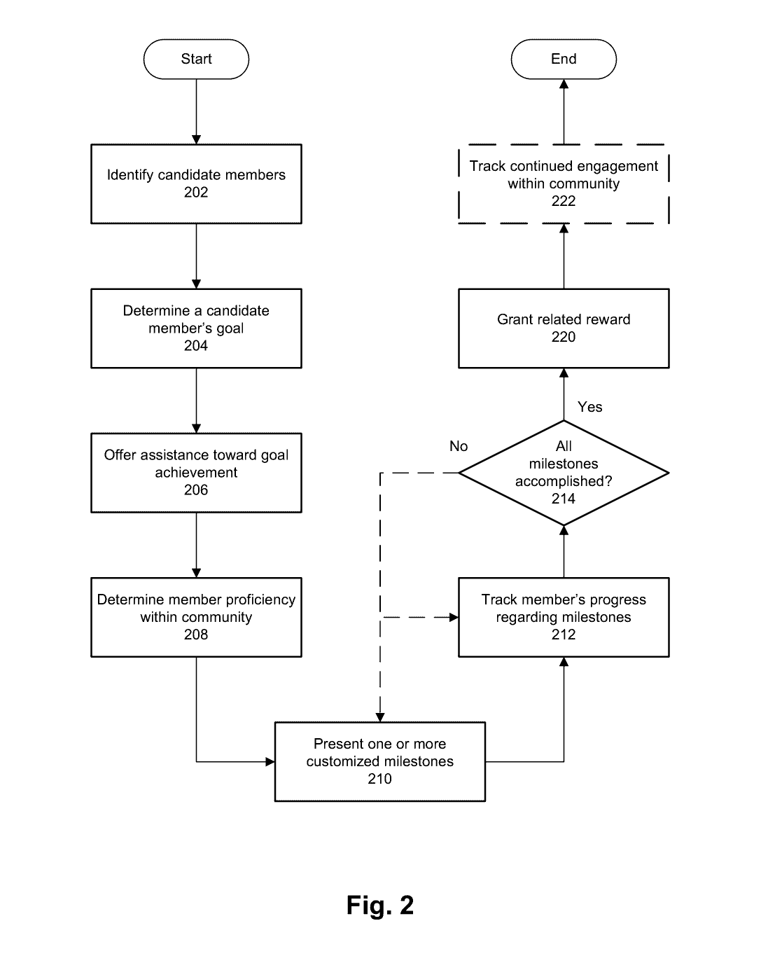

FIG. 2 is a flow chart illustrating a method of promoting achievement of goals within a professional community, according to some embodiments. In other embodiments, one or more of the illustrated operations may be omitted, repeated, and/or performed in a different order. Accordingly, the specific arrangement of steps shown in FIG. 2 should not be construed as limiting the scope of the embodiments.

In operation 202, some members of an online professional community (e.g., a community of members of a professional network or professional social network) are identified as candidates for assisted or guided achievement of a goal within the community. In different implementations, these candidate members may be identified in different ways.

For example, in some implementations, candidates may include members of the community who have not achieved some threshold level of proficiency, interaction, or experience with the community, as measured by any suitable metric(s): completion of a registration process, completion of a profile of the member, completion of a threshold portion or one or more particular aspects of the member's profile, acquisition of a threshold number of connections within the community, number of connection requests sent (or received), import or upload of relevant data (e.g., an address book, a list of contacts), download of a threshold number of applications or features of the community and/or particular applications or features, addition of a threshold number of skills, following a threshold number of other members and/or content sources/channels, inviting a threshold number of non-members to join the community, awarding a threshold number of endorsements and/or recommendations to other members, receiving a threshold number of endorsements and/or recommendations sharing or posting a threshold number of items, frequency and/or length of sessions of use of the online professional community, number of content items accessed within the community, and so on.

In short, virtually any activity or type of information within the community may serve as a metric for identifying candidates among the community's members and/or for determining a member's proficiency within (or familiarity with) the community. Some or all of these metrics may also be adopted as milestones for guiding or assisting a member to reach a goal within the community, and/or some or all milestones suggested to a member to help him or her progress toward a goal may be used as metrics for identifying candidate members, determining a member's proficiency within the community, and/or for other purposes.

In other implementations, all new members or all members who have (or have not) been members for a threshold period of time may be automatically considered candidates for assisted or guided achievement of a goal. In yet other implementations, some members may simply be queried as to whether they wish to receive assistance with use of the community and/or achievement of a professional goal.

In operation 204, a professional goal of a candidate member is determined. This goal may be explicitly learned by asking the member while she is online, may be inferred from her activity and interaction within the community, and/or via offline communication (e.g., electronic mail, instant message).

For example, as part of a registration process with the online professional community, within a splash page, or as part of the member's home page within the community, the member may be asked to identify one or more goals. A number of illustrative goals may be offered to her, and/or she may identify her own goal.

In some embodiments, preconfigured goals that may be suggested to a candidate member are categorized according to general objectives within, or use of, the online professional community. Illustrative categories include “Identity,” “Network,” and “Knowledge,” wherein Identity goals may relate to identifying or characterizing oneself within the community, Network goals may relate to forming connections with other members, and Knowledge goals may relate to accessing professional content (e.g., information) within the community.

These illustrative categories (and/or others) may themselves be used as goals, and/or goals may be proposed within one or more categories. For example, illustrative specific goals may include “Find a job,” “Build my professional network,” “Keep in touch with people,” “Stay informed,” and so on.

In some embodiments, a member's goal is inferred from her activity within the community. Thus, if she spends a substantial percentage of her time online working on her profile, she may have an Identity goal, or if she visits pages identifying job opportunities, her goal may be to find a job. Similarly, if she spends a significant amount of time searching for other members or searching for professional content, she may have a Network or Knowledge goal, respectively.

In operation 206, one or more candidate members are selected and offered assistance toward achieving their goals. An offer may be presented while a member is online (e.g., as part of a login or registration process), and/or may be offered via an offline communication.

In different embodiments, different criteria may be considered when selecting candidates to whom assistance will be offered. For example, some or all members who select a particular goal may automatically be offered assistance, while members having other goals may be selectively chosen, based on their lack of progress toward those goals, as based on observation of their activity, and/or other criteria. Thus, if a given user having a given goal fails to accomplish some number of metrics or milestones toward that goal (e.g., among the metrics and milestones discussed herein), he or she may be offered assistance, while another member having the same goal but having greater success in accomplishing related metrics or milestones may not. As another consideration, assistance may be offered to a member with a relatively low level of engagement with the community (e.g., he or she visits the community infrequently).

In operation 208, for each member to whom assistance was offered and the offer was accepted—which may be referred to as targeted (or target) members—the member's proficiency or familiarity with the online professional community is determined, especially with regard to the member's goal, if that proficiency was not already determined. For example, and as mentioned above, a member's proficiency may have been determined as part of a process of inferring his or her professional goal or as part of selecting candidate members to whom assistance should be offered.

If not already determined, the member's proficiency may be measured by determining how many (if any) predetermined milestones associated with his or her goal have been completed, examining how often the member connects and/or the length of time the member remains connected, identifying how many different features/applications/services of the online professional community the member has accessed, querying the member directly, and so on.

In some embodiments, a member's proficiency may reflect the frequency with which the member tends to connect to the online professional community. For example, a member who connects frequently may be characterized as a “daily” user and may be assumed to have a relatively advanced or high level of proficiency within the community. A member who connects less frequently may be deemed a “weekly” user and may be assumed to have a normal or medium level of proficiency. A member who connects infrequently may be characterized as a “monthly” user and may be assumed to have little proficiency.

These measures of proficiency may be made based on a member's average rate of connection, and need not be exact as long as they reflect members' general levels of familiarity with use of features offered by the community. Different characterizations may be used in different embodiments, and any number (e.g., two or more) may be used.

In operation 210, based on the member's level of proficiency within the online community, especially with regard to his or her professional goal, one or more (e.g., 3, 5, 7) customized milestones are suggested to targeted members who accepted offers of assistance. The milestones are related to the member's goal, and may be selected from a pool of predetermined milestones having various levels of difficulty or complexity. In the method illustrated in FIG. 2, the level of proficiency of the member will determine the difficulty or complexity of milestones suggested to that member.

Thus, for a novice member who recently joined the community and who has spent little time exploring what the community offers, relatively simple milestones may be suggested. Conversely, for a relatively experienced member, harder milestones, or even the most complex/difficult milestones, may be suggested. The number of milestones suggested may differ from one implementation to another, and may also depend on the member's proficiency or experience with the community. Milestones that the member has already accomplished prior to the offer of assistance generally will not be suggested.

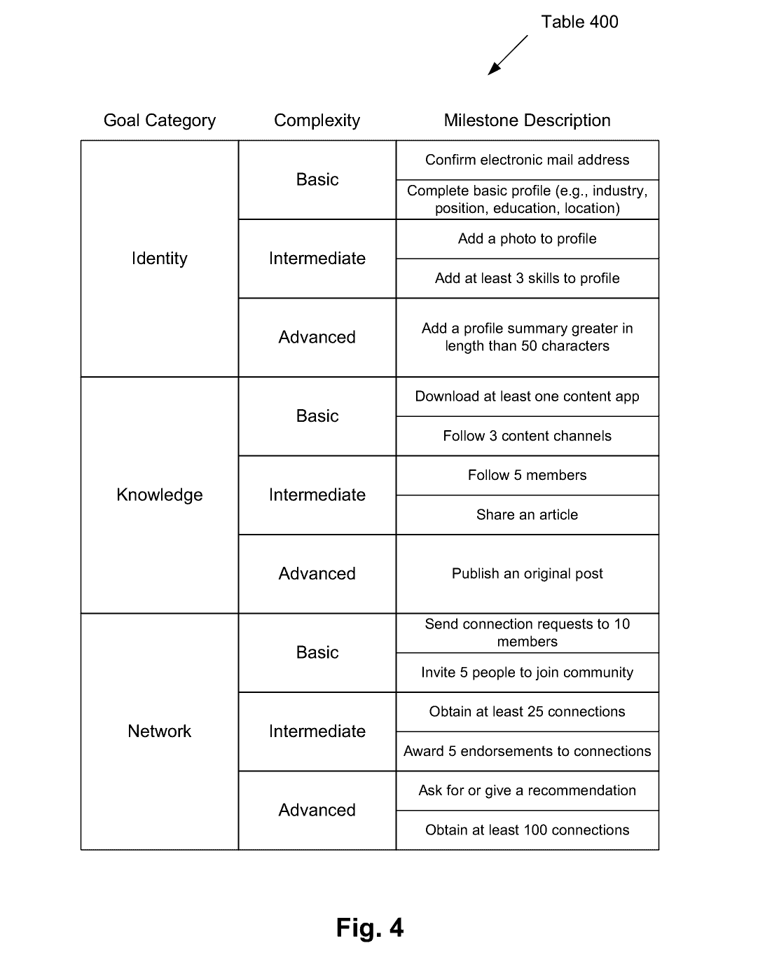

FIG. 4 is a table identifying milestones that may be suggested to members, according to some embodiments. In these embodiments, three categories of goals are established and, within each category, related milestones are divided into three levels or classes of complexity—basic, intermediate, and advanced, which correspond to member proficiency levels.

In other embodiments, any number of goal categories and milestone complexities may be employed, and any number of individual milestones may be available. Thus, individual embodiments are not limited to the categories, complexity levels, and milestones of Table 400. For example, a given milestone may be included in more than one level of complexity, and/or may be associated with more than category of goal.

In operation 212, the member's progress toward completion of the milestones is tracked. This may simply entail noting each milestone that is completed. A scorecard, summary, or other presentation may be displayed for the member to show her progress toward the set of milestones and/or her progress toward completion of individual milestones. For example, her home page may include a link to a ‘milestone scorecard’ that lists the suggested milestones, shows which ones have (and/or have not) been completed, and which may indicate a degree to which a particular milestone has been completed.

In some implementations, a scorecard or other presentation to a member of suggested milestones may include links to perform or at least initiate a milestone. For example, a milestone such as “Follow 3 content sources” may include a link to a collection of content channels, influencers (i.e., influential members), and/or other sources, from which the member may select sources to follow. The content sources that are shown may be related to the member's industry, position, employer, and/or other attribute(s). Further, the display of suggested milestones may be immediately updated when the member completes a milestone.

In some embodiments, a milestone may be altered (or replaced) prior to its completion if, for example, the member does not make much (or any) progress toward its completion. For example, if a particular milestone requires repetition of a discrete action (e.g., sending a connection request, accessing an item of content, completing a particular portion or percentage of her profile), the milestone may be adjusted to require fewer repetitions.

In operation 214, the system determines whether the member has completed the suggested milestones. If so, the method advances to operation 220. Otherwise, the method may return to operation 210 (e.g., to alter or replace a milestone with a customized milestone) or operation 212 (to continuing tracking her progress).

In operation 220, an appropriate reward is granted to or bestowed upon the member, preferably a reward that is related to the member's goal or to the member's use of the professional community. For example, the member may be temporarily granted a higher level account (e.g., a premium account), may be granted access to an additional service, application, or feature that was not previously available to her, etc.

As another example, if the member's goal was to find a job, and she completed the suggested milestones (e.g., update her profile, import her résumé, do a job search, follow one or companies she'd like to work for), her reward may be a free trial of a “job seeker” account or status that allows her to communicate with potential employers (e.g., to send her resume, to inquire about available positions) or that allows her to freely browse job openings posted by employers, or to access additional openings that she would not otherwise be able to access.

As yet another example, if the member's goal was a “Knowledge” goal, and she completed the suggested tasks (e.g., follow one or more suggested content channels and/or influencers, download an application such as LinkedIn® Pulse (available on the Internet at the Uniform Resource Locator associated with http://www.pulse.me)), she may be granted a free trial subscription to a premium source of content (e.g., an online publication).

In optional operation 222, the system continues to track the member's engagement with or within the online professional community. For example, the system may determine whether (and to what extent) the member continues to use or explore the community's services, may monitor additional progress toward the member's stated or inferred goal, and may return to a previous operation to offer additional assistance (e.g., additional milestones that are more complex).

After operation 222, the method ends.

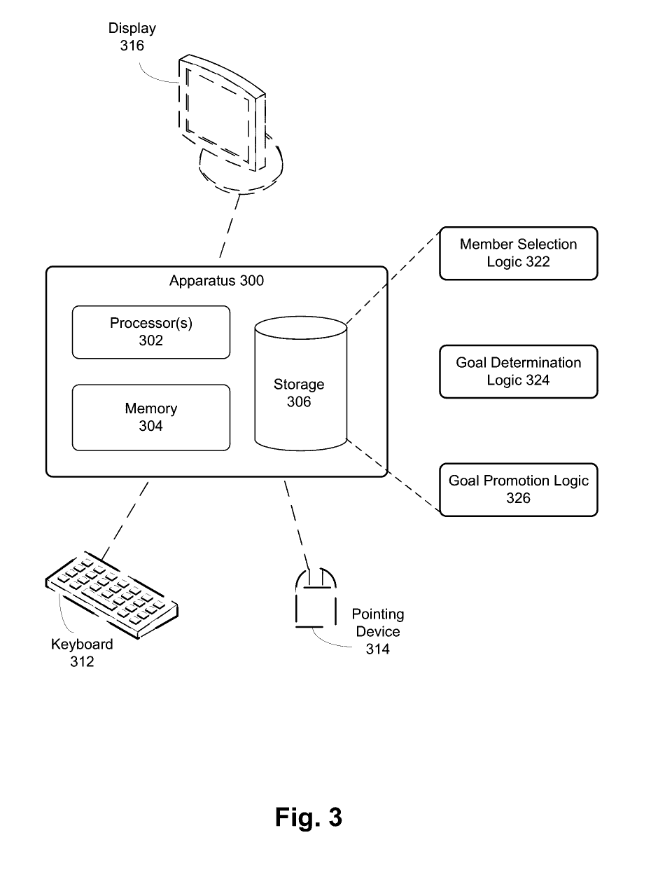

FIG. 3 is a block diagram of an apparatus for promoting achievement of goals within a professional community, according to some embodiments.

Apparatus 300 of FIG. 3 includes processor(s) 302, memory 304, and storage 306, which may comprise one or more optical, solid-state, and/or magnetic storage components. Storage 306 may be local to or remote from the apparatus. Apparatus 300 can be coupled (permanently or temporarily) to keyboard 312, pointing device 314, and display 316.

Storage 306 stores logic that may be loaded into memory 304 for execution by processor(s) 302. Such logic includes member selection logic 322, goal determination logic 324, and goal promotion logic 326. In other embodiments, a logic module may be divided to separate its functionality as desired, or multiple logic modules may be combined or merged.

Member selection logic 322 comprises processor-executable instructions for identifying members of an online professional community as candidates for assisted achievement of a goal within the community, and/or for selecting one or more of those candidates as targets to receive offers of assistance. As indicated above, these selections may be based on various criteria, such as how long someone has been a member of the community, their level of proficiency with and/or use of the community's features, services, and applications, and so on.

Goal determination logic 324 comprises processor-executable instructions for determining goals of members of the professional community. For example, after a collection of candidate members is assembled, logic 324 may be executed to identify their goals, explicitly (e.g., by asking the members) and/or implicitly (e.g., by inference, based on their community activity).

Goal promotion logic 326 comprises processor-executable instructions for promoting achievement of members' goals. As described above, in some embodiments this involves suggesting to a member one or more milestones involving action within the community that is related to the member's goal, tracking completion of those milestones, and possibly bestowing an appropriate reward upon the member when the milestones are completed.

In some embodiments, apparatus 300 performs some or all of the functions ascribed to one or more components of system 110 of FIG. 1.

An environment in which one or more embodiments described above are executed may incorporate a general-purpose computer or a special-purpose device such as a hand-held computer or communication device. Some details of such devices (e.g., processor, memory, data storage, display) may be omitted for the sake of clarity. A component such as a processor or memory to which one or more tasks or functions are attributed may be a general component temporarily configured to perform the specified task or function, or may be a specific component manufactured to perform the task or function. The term “processor” as used herein refers to one or more electronic circuits, devices, chips, processing cores and/or other components configured to process data and/or computer program code.

Data structures and program code described in this detailed description are typically stored on a non-transitory computer-readable storage medium, which may be any device or medium that can store code and/or data for use by a computer system. Non-transitory computer-readable storage media include, but are not limited to, volatile memory; non-volatile memory; electrical, magnetic, and optical storage devices such as disk drives, magnetic tape, CDs (compact discs) and DVDs (digital versatile discs or digital video discs), solid-state drives, and/or other non-transitory computer-readable media now known or later developed.

Methods and processes described in the detailed description can be embodied as code and/or data, which may be stored in a non-transitory computer-readable storage medium as described above. When a processor or computer system reads and executes the code and manipulates the data stored on the medium, the processor or computer system performs the methods and processes embodied as code and data structures and stored within the medium.

Furthermore, the methods and processes may be programmed into hardware modules such as, but not limited to, application-specific integrated circuit (ASIC) chips, field-programmable gate arrays (FPGAs), and other programmable-logic devices now known or hereafter developed. When such a hardware module is activated, it performs the methods and processed included within the module.

The foregoing embodiments have been presented for purposes of illustration and description only. They are not intended to be exhaustive or to limit this disclosure to the forms disclosed. Accordingly, many modifications and variations will be apparent to practitioners skilled in the art. The scope is defined by the appended claims, not the preceding disclosure.

1. A method for promoting achievement of goals for a member of an online professional community, comprising:
providing, to a first client device, a user-interface application to facilitate content entry and content display for a first member of the online professional community, wherein the user-interface is provided from a server comprising a memory and a processor;
identifying multiple members of the online professional community as candidates for assisted achievement of a professional goal, including the first member;
receiving, at a portal, from the first member of the online professional community at the first client device, one or more requests to begin one or more interactive sessions within the online professional community, wherein the request is received over the Internet, wherein the request is entered by the first member at the user-interface application on the client device, wherein the interactive sessions are conducted by the first member at the user-interface on the client device, wherein the portal comprises a processor and a memory, and wherein the portal is a gateway entry point for communication with the client device;
recording, by a tracking server in association with the portal, activities conducted between the client device and the portal during the one or more interactive sessions, wherein the tracking server comprises a processor and a memory;
evaluating, based on the recorded activities, metric values associated with the interactive sessions between the client device and the portal, wherein the metric values involve at least one of: a frequency of the interactive sessions at the client device, and a duration of the interactive sessions at the client device;
determining, based on the evaluated metric values, a level of proficiency of the first member and a professional goal to be met by the first member;
based on the determined level of proficiency, identifying a set of milestones associated with achievement of the first professional goal;
automatically transmitting the identified set of milestones, via the portal, to the client device;
displaying, at the user-interface on the client device, the identified set of milestones;
receiving, from the tracking server, further recorded activities of the first member within the online community;
upon determining, based on the further recorded activities, that the first user has completed one or more of the identified milestones;
transmitting, to the client device, from the transmission server, notification of the successful completion of the one or more milestones; and
triggering a display, at the user-interface on the client display, of the notification; and
upon determining, based on the further recorded activities, completion of all the milestones in the set of milestones, transmitting, to the client device, a notification of a reward related to at least one of: the first professional goal, and the first member's use of the professional online community.

2. The method of claim 1, wherein said identifying multiple members of the professional community as candidates comprises one or more of:
identifying members of the online professional community who have less than a threshold number of connections to other members of the online professional community;
identifying members of the online professional community who have completed less than a threshold portion of a profile;
identifying members of the online professional community who have subscribed to less than a threshold number of professional content sources; and
identifying members of the online professional community who follow less than a threshold number of other members of the online professional community.

3. The method of claim 1, wherein said presenting to the first member a set of milestones comprises:
from a pool of milestones associated with the first professional goal, selecting a set of milestones having a level of complexity proportional to the level of proficiency;
wherein a second member of the online professional community having the first professional goal but a different level of proficiency than the first member is presented a different set of milestones.

4. The method of claim 1, wherein said determining a level of proficiency of the first member comprises:
for each of multiple metrics within the online professional community, determining a level of completion of the multiple metrics by the first member.

5. The method of claim 1, further comprising:
after transmitting notification of the reward, presenting to the first member a second set of milestones associated with the first professional goal, wherein the second set of milestones requires actions more complex than the first set of milestones; and
tracking completion of the second set of milestones by the first member.

6. The method of claim 1, wherein said determining a first professional goal of the first member further comprises:
querying the first member during a session of use of the online professional community by the first member.

7. (canceled)

8. An apparatus, comprising:
one or more processors; and
memory storing instructions that, when executed by the one or more processors, cause the apparatus to:
provide, to a first client device, a user-interface application to facilitate content entry and content display for a first member of the online professional community, wherein the user-interface is provided from a server comprising a memory and a processor;
identify multiple members of the online professional community as candidates for assisted achievement of a professional goal, including the first member;
receive, at a portal, from the first member of the online professional community at the first client device, one or more requests to begin one or more interactive sessions within the online professional community, wherein the request is received over the Internet, wherein the request is entered by the first member at the user-interface application on the client device, wherein the interactive sessions are conducted by the first member at the user-interface on the client device, wherein the portal comprises a processor and a memory, and wherein the portal is a gateway entry point for communication with the client device;
record, by a tracking server in association with the portal, activities conducted between the client device and the portal during the one or more interactive sessions, wherein the tracking server comprises a processor and a memory;
evaluate, based on the recorded activities, metric values associated with the interactive sessions between the client device and the portal, wherein the metric values involve at least one of: a frequency of the interactive sessions at the client device, and a duration of the interactive sessions at the client device;
determine, based on the evaluated metric values, a level of proficiency of the first member, and a professional goal to be met by the first member;
based on the determined level of proficiency, identify a set of milestones associated with achievement of the first professional goal;
automatically transmit the identified set of milestones, via the portal, to the client device;
display, at the user-interface on the client device, the identified set of milestones;
receive, from the tracking server, further recorded activities of the first member within the online community;
upon determining, based on the further recorded activities, that the first user has completed one or more of the identified milestones;
transmit, to the client device, from the transmission server, notification of the successful completion of the one or more milestones; and
trigger a display, at the user-interface on the client display, of the notification; and
upon determining, based on the further recorded activities, completion of all the milestones in the set of milestones, transmit, to the client device, a notification of a reward related to at least one of: the first professional goal, and the first member's use of the professional online community.

9. The apparatus of claim 8, wherein said identifying multiple members of the professional community as candidates comprises one or more of:
identifying members of the online professional community who have less than a threshold number of connections to other members of the online professional community;
identifying members of the online professional community who have completed less than a threshold portion of a profile;
identifying members of the online professional community who have subscribed to less than a threshold number of professional content sources; and
identifying members of the online professional community who follow less than a threshold number of other members of the online professional community.

10. The apparatus of claim 8, wherein said presenting to the first member a set of milestones comprises:
from a pool of milestones associated with the first professional goal, selecting a set of milestones having a level of complexity proportional to the level of proficiency;
wherein a second member of the online professional community having the first professional goal but a different level of proficiency than the first member is presented a different set of milestones.

11. The apparatus of claim 8, wherein said determining a level of proficiency of the first member comprises:
for each of multiple metrics within the online professional community, determining a level of completion of the multiple metrics by the first member.

12. The apparatus of claim 8, wherein the memory further stores instructions that, when executed by the one or more processors, cause the apparatus to:
after transmitting notification of the reward, present to the first member a second set of milestones associated with the first professional goal, wherein the second set of milestones requires actions more complex than the first set of milestones; and
track completion of the second set of milestones by the first member.

13. The apparatus of claim 8, wherein said determining a first professional goal of the first member further comprises:
querying the first member during a session of use of the online professional community by the first member.

14. (canceled)

15. A system, comprising:
one or more processors;
a providing module comprising a non-transitory computer-readable medium storing instructions that, when executed, cause the system to provide, to a first client device, a user-interface application to facilitate content entry and content display for a first member of the online professional community, wherein the user-interface is provided from a server comprising a memory and a processor;
a member selection module comprising a non-transitory computer-readable medium storing instructions that, when executed, cause the system to identify multiple members of the online professional community as candidates for assisted achievement of a professional goal, including the first member;
a goal determination module comprising a non-transitory computer-readable medium storing instructions that, when executed, cause the system to
receive, at a portal, from the first member of the online professional community at the first client device, one or more requests to begin one or more interactive sessions within the online professional community, wherein the request is received over the Internet, wherein the request is entered by the first member at the user-interface application on the client device, wherein the interactive sessions are conducted by the first member at the user-interface on the client device, wherein the portal comprises a processor and a memory, and wherein the portal is a gateway entry point for communication with the client device;
record, by a tracking server in association with the portal, activities conducted between the client device and the portal during the one or more interactive sessions, wherein the tracking server comprises a processor and a memory;
evaluate, based on the recorded activities, metric values associated with the interactive sessions between the client device and the portal, wherein the metric values involve at least one of: a frequency of the interactive sessions at the client device, and a duration of the interactive sessions at the client device; and
determine, based on the evaluated metric values, a level of proficiency of the first member, and a professional goal to be met by the first member; and
a goal promotion module comprising a non-transitory computer-readable medium storing instructions that, when executed, cause the system to:
based on the determined level of proficiency, identify a set of milestones associated with achievement of the first professional goal;
automatically transmit the identified set of milestones, via the portal, to the client device;
display, at the user-interface on the client device, the identified set of milestones;
receive, from the tracking server, further recorded activities of the first member within the online community; and
upon determining, based on the further recorded activities, that the first user has completed one or more of the identified milestones;
transmit, to the client device, from the transmission server, notification of the successful completion of the one or more milestones; and
trigger a display, at the user-interface on the client display, of the notification; and
upon determining, based on the further recorded activities, completion of all the milestones in the set of milestones, transmit, to the client device, a notification of a reward related to at least one of: the first professional goal, and the first member's use of the professional online community.

16. The system of claim 15, wherein said identifying multiple members of the professional community as candidates comprises one or more of:
identifying members of the online professional community who have less than a threshold number of connections to other members of the online professional community;
identifying members of the online professional community who have completed less than a threshold portion of a profile;
identifying members of the online professional community who have subscribed to less than a threshold number of professional content sources; and
identifying members of the online professional community who follow less than a threshold number of other members of the online professional community.

17. The system of claim 15, wherein said presenting to the first member a set of milestones comprises:
from a pool of milestones associated with the first professional goal, selecting a set of milestones having a level of complexity proportional to the level of proficiency;
wherein a second member of the online professional community having the first professional goal but a different level of proficiency than the first member is presented a different set of milestones.

18. The system of claim 15, wherein said determining a level of proficiency of the first member comprises:
for each of multiple metrics within the online professional community, determining a level of completion of the multiple metrics by the first member.

19. The system of claim 17, wherein the non-transitory computer-readable medium of the goal promotion module further stores instructions that, when executed by the one or more processors, cause the system to:
after transmitting notification of the reward, present to the first member a second set of milestones associated with the first professional goal, wherein the second set of milestones requires actions more complex than the first set of milestones; and
track completion of the second set of milestones by the first member.

20-23. (canceled)
